(19) United States
(12) Patent Application Publication
(10) Pub. No.: US 2013/0024082 A1
(43) Pub. Date: Jan. 24, 2013

(54) CONTROL SYSTEM AND METHOD FOR A CAR

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/287,116

(22) Filed: Nov. 1, 2011

(30) Foreign Application Priority Data
Jul. 20, 2011 (TW) 100125711

(51) Int. Cl. F02D 28/00

(52) U.S. Cl. 701/70

(57) ABSTRACT

A control system for a car includes an acceleration sensor, a transforming unit, an analyzing unit, and a control unit. The acceleration sensor detects a movement of an accelerator pedal of the car. The transforming unit transforms the movement of the accelerator pedal into a waveform chart. The analyzing unit analyzes the waveform chart, and determines whether the accelerator pedal is moving rapidly according to the movement. The control unit prevents the car from accelerating when the accelerator pedal moves rapidly.

### BACKGROUND

1. Technical Field

The present disclosure relates to control system, and particularly, to a control system for a car.

2. Description of Related Art

Inexperienced car drivers may mistake the accelerator pedal with the brake pedal when they need make an emergency stop. Stepping on the accelerator pedal by mistake rather than the brake pedal will not stop but will accelerate the car, and likely results in terrible car accidents.

### BRIEF DESCRIPTION OF THE DRAWINGS

The components in the drawings are not necessarily drawn to scale, the emphasis instead being placed upon clearly illustrating the principles of a control system and method for a car. Moreover, in the drawings, like reference numerals designate corresponding parts throughout the several views.

FIG. 1 is a block diagram of a control system in accordance with an exemplary embodiment.

FIG. 2 shows an acceleration pedal with an acceleration sensor of FIG. 1.

FIG. 3 is a waveform chart when the acceleration pedal moves smoothly.

FIG. 4 is another waveform chart when the acceleration pedal moves rapidly.

FIG. 5 is a flowchart of a control method in accordance with an exemplary embodiment.

### DETAILED DESCRIPTION

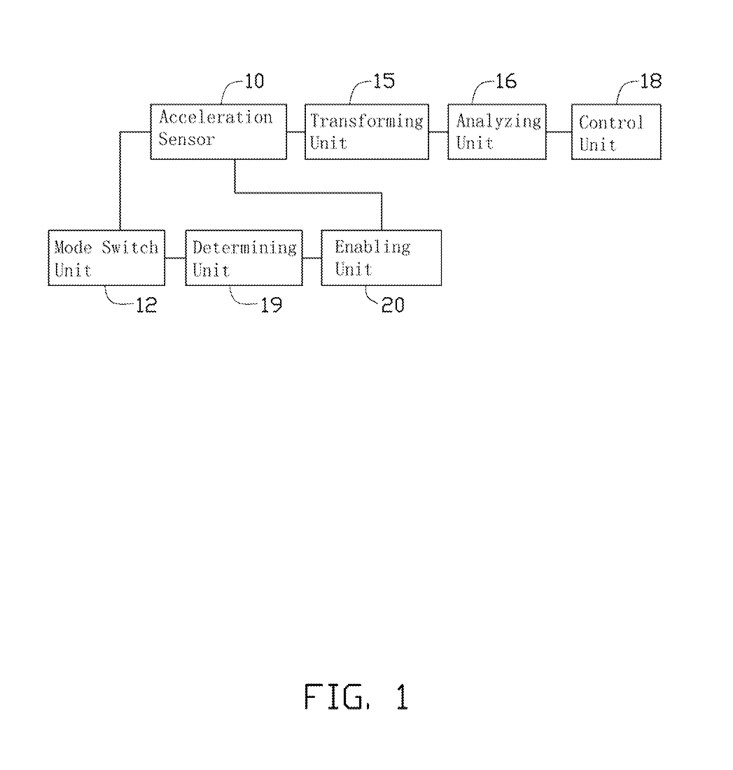

Referring to FIG. 1, a control system for a car includes an acceleration sensor 10, a mode switch unit 12, a transforming unit 15, an analyzing unit 16, a control unit 18, a status determining unit 19, and an enabling unit 20.

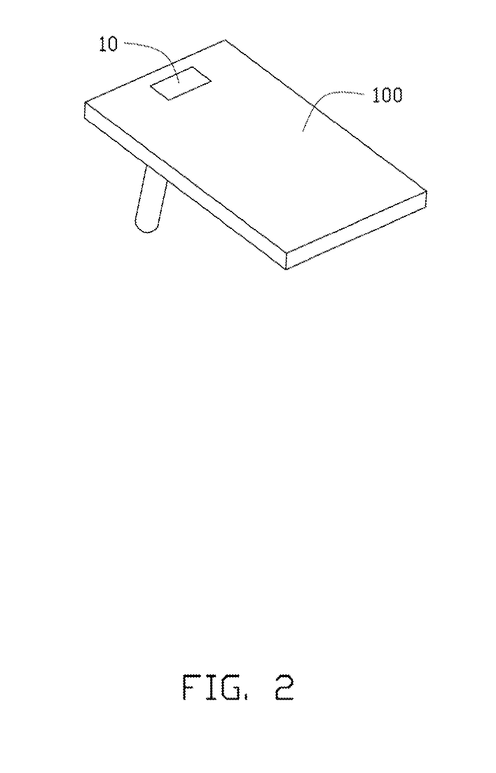

Referring to FIG. 2, the acceleration sensor 10 is positioned on an accelerator pedal 100 of the car to detect the movement of the accelerator pedal 100. The transforming unit 15 acquires the movement from the acceleration sensor 10, and transforms the movement to a waveform chart.

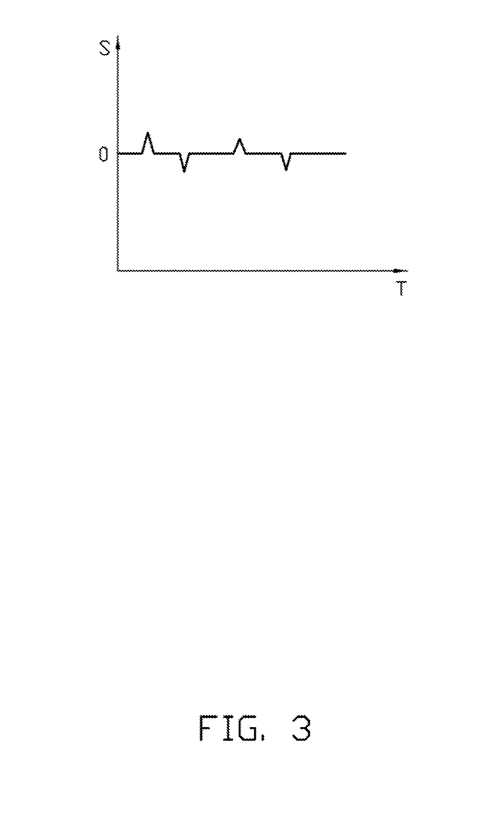

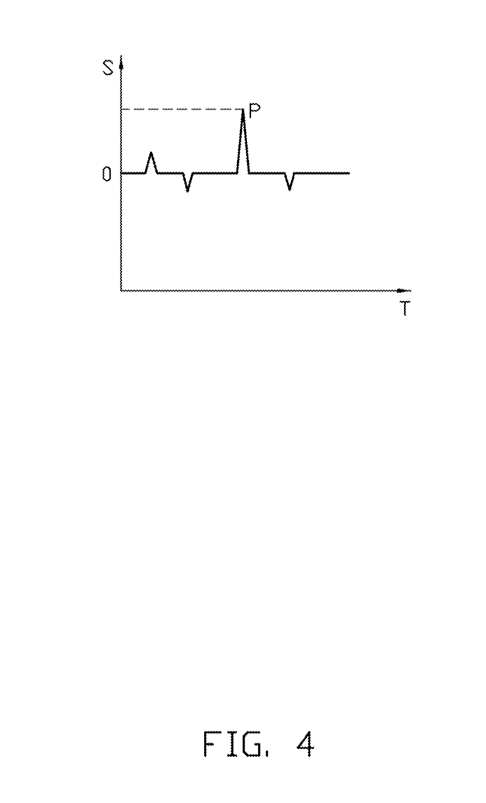

The analyzing unit 16 analyzes the waveform chart to determine whether the accelerator is stepped on forcefully, and thus is moved rapidly. In general, the accelerator pedal 100 should move smoothly to drive the car steadily, and the waveform transformed from the movement of the accelerator pedal 100 is steady (FIG. 3). When the driver needs to perform an emergency stop but mistakenly steps on the accelerator pedal 100 instead of the brake pedal, the accelerator pedal 100 is forcefully stepped on and the waveform appears to peak (indicated as “P” in FIG. 4). The analyzing unit 16 determines the accelerator is mistaken as the brake pedal when the peak in the waveform appears. In other embodiments, the analyzing unit 16 can directly analyze the movement of the accelerator pedal 100 without the waveform chart generated by the transforming unit 15. When determining the accelerator pedal 100 is mistaken as the brake pedal, the control unit 18 is initiated, and the movement of the accelerator pedal 100 is ignored to stop the car from acceleration.

The mode switch unit 12 is used to switch the control system between auto mode and enabled mode. When the control system is switched to the enabled mode, the acceleration sensor 10, the transforming unit 15, the analyzing unit 16, and the control unit 18 is initiated. When the control system is switched to auto mode, the status determining unit 19 detects the speed of the car. In general, the driver should step on the accelerator pedal 100 smoothly when the car is moving at high speed because the car is already at high speed, and stepping the accelerator pedal 100 forcefully may indicate the driver has mistaken the accelerator pedal 100 as the brake pedal. In the present embodiment, when the car speed reaches 100 km/hr, the status determining unit 19 determines the car to be at a high speed status, and the acceleration sensor 10, the transforming unit 15, the analyzing unit 16, and the control unit 18 is initiated.

Furthermore, the status determining unit 19 can detect the gear position of the car. In general, the driver should step on the accelerator pedal 100 slightly when the car is in reverse gear, and seldom steps on the acceleration pedal forcefully. In the present embodiment, the acceleration sensor 10, the transforming unit 15, the analyzing unit 16, and the control unit 18 are initiated when the car is determined to be in reverse gear by the status determining unit 19 to prevent the driver from a sudden unintended acceleration in reverse because of mistaking the accelerator pedal 100 for the brake pedal. In other embodiments, the control system can have only the auto mode, and the mode switch unit 12, the status determining unit 19, and the enabling unit 20 is no longer needed.

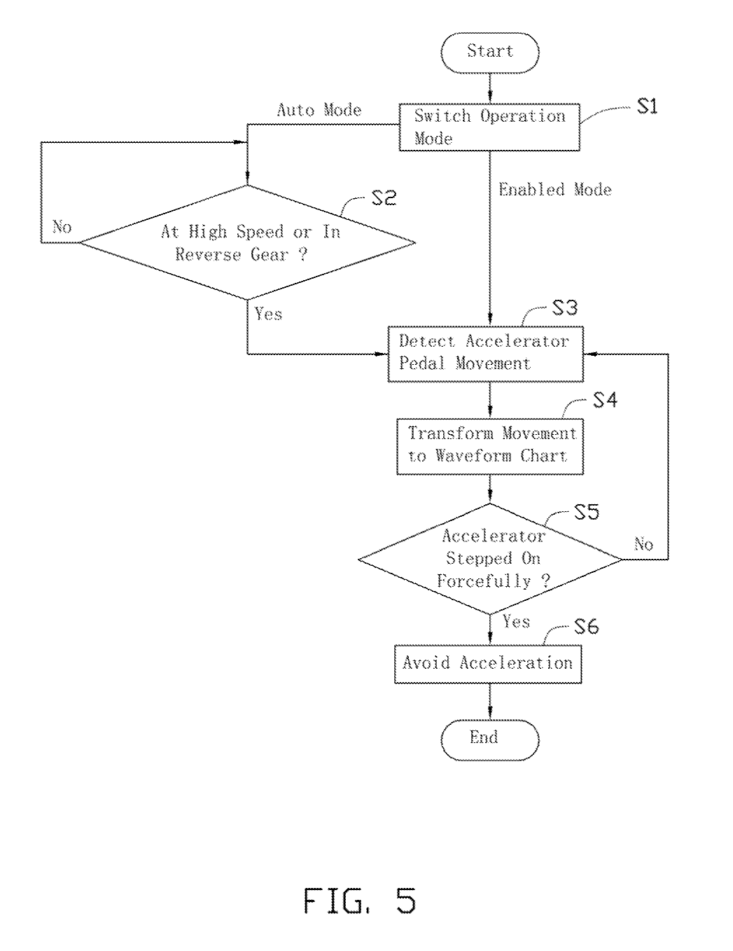

FIG. 5 shows a flowchart of the control method for cars. In step S1, the control system can be switched between the auto mode and enabled mode with the mode switch unit 12; if the control system is switched to auto mode, the method goes to step S2; if the control system is switched to enabled mode, it goes to step S3. In step S2, the status determining unit 19 determines whether the car is at high speed or in reverse gear; if the car is at high speed or in reverse gear, it goes to step S3. In step S3, the acceleration sensor 10 detects the movement of the accelerator pedal 100. In step S4, the transforming unit 15 transforms the movement of the accelerator pedal 100 to waveform chart. In step S5, the analyzing unit 16 analyzes the waveform chart to determine whether the accelerator pedal 100 is stepped on forcefully; if the accelerator pedal 100 is stepped on forcefully, it goes to step S6; if the accelerator pedal 100 is not stepped on forcefully, it goes to step S3. In step S6, the movement of the accelerator pedal 100 is ignored to stop the car from acceleration.

Therefore, the control system and method for cars can avoid sudden unintended acceleration, particularly when the car is at high speed or in reverse gear.

Although the present disclosure has been specifically described on the basis of this exemplary embodiment, the disclosure is not to be construed as being limited thereto. Various changes or modifications may be made to the embodiment without departing from the scope and spirit of the disclosure.

What is claimed is:

1. A control system for a car, comprising:
an acceleration sensor for detecting movement of an accelerator pedal of the car;
an analyzing unit for analyzing the movement, and determining whether the accelerator pedal moves rapidly according to the movement; and
a control unit for preventing the car from accelerating when the accelerator pedal moves rapidly.

2. The control system as claimed in claim 1, further comprising a transforming unit for transforming the movement of the accelerator pedal into a waveform chart, and the analyzing unit analyzing the waveform chart to determine whether the accelerator pedal is moving rapidly.

3. The control system as claimed in claim 1, further comprising:
a mode switch unit for setting a first mode or a second mode for the control system, wherein the acceleration sensor, the analyzing unit, and the control unit is initiated when the control system is set to the first mode;
a status determining unit for determining whether the car speed is above a pre-determined threshold, or the car is in reverse gear; and
an enabling unit for initiating the acceleration sensor, the analyzing unit, and the control unit when the car speed is above the pre-determined threshold, or the car is in reverse gear.

4. The control system as claimed in claim 1, wherein the acceleration sensor is arranged on the accelerator pedal.

5. A control method for controlling a car, comprising:
detecting movement of an accelerator pedal of the car;
determine whether the accelerator pedal is moving rapidly according to the movement; and
controlling the car not to accelerate when the accelerator pedal moves rapidly.

6. The control method as claimed in claim 5, further comprising:
transforming the movement into a waveform chart which is used to determine whether the accelerator pedal is moving rapidly according to the movement of the accelerator pedal.

7. A control method for controlling a car, comprising:
determining whether a speed of the car is above a pre-determined threshold, or the car is in reverse gear when the control system is set to the auto mode;
detecting the movement when the speed is above a pre-determined threshold, or the car is in reverse gear;
transforming the movement into a waveform chart which is used to determine whether the accelerator pedal moves rapidly according to the movement of the accelerator pedal; and
controlling the car not to accelerate when the accelerator pedal moves rapidly.
